(19) United States
(12) Patent Application Publication
(10) Pub. No.: US 2002/0040477 A1
(43) Pub. Date: Apr. 4, 2002

(54) Radio transmission of data representing television programs

(76) Inventors: Gero Baese, Munchen (DE); Andre Fischer, Berlin (DE); Martin Gebler, Pulach im Isartal (DE); Sabine Markgraf, Gauting (DE); Peter Moritz, Haar (DE); Stefan Prange, Munchen (DE); Annette Schlossnikel, Munchen (DE); Arnd Sibila, Moorenweis (DE); Thomas Strobel, Gauting (DE); Christian Von Brockdorff, Icking (DE); Juergen Wilde, Taufkirchen (DE)

Correspondence Address: Bell, Boyd & Lloyd LLC, P.O. Box 1135, Chicago, IL, 60690-1135, US

(21) Appl. No.: 09/963,981

(22) Filed: Sep. 26, 2001

(30) Foreign Application Priority Data
Sep. 26, 2000 (DE) 10047608.2
Jan. 25, 2001 (DE) 10103291.9

(51) Int. Cl. H04N 7/20

(52) U.S. Cl. 725/73

(57) ABSTRACT

Apparatuses and methods for radio transmission of data which represents the contents of a television program. The data is transmitted from a television transmitter to a mobile radio terminal 8 of a terminal user 9. The data includes information, for example, text information, which represents the program. The data can be displayed on a display 10 of the terminal 8 or stored in the terminal 8 and displayed as desired.

### BACKGROUND OF THE INVENTION

The invention relates to methods and apparatuses for radio transmission of data, representing the contents of a television program, from a transmitter to a mobile radio terminal.

Television is a widespread medium used intensively by large sections of the population. One of the major television medium items is, in particular, series programs, such as, soap operas and sports programs. For regular television medium users, it is highly important not to miss regularly watched programs. Portable televisions and radios are known in order to solve this problem. However, the reception conditions when used while travelling are in some cases inadequate. Additionally, the portability of the mobile appliances used at the reception end according to this solution is less than optimum. Television users have recorded relevant programs on video. But, video recording of television programs involves the disadvantage that there is a time delay between the time of the broadcast or transmission and the time the video recorded program is seen. Such time delays are often unacceptable to the users, particularly for sporting events.

### SUMMARY OF THE INVENTION

The present invention pertains to radio transmission of data relating to television programs. Data, for example text information, representing the contents of the television program is transmitted from a device at the television transmitter end via a mobile radio network to a mobile radio terminal of a terminal user. The transmitted data may contain only text data which allows simple, cost-effective transmission to a mobile radio terminal. One example of data transmitted by the present invention is the content corresponding to a football game with commentary.

The transmission of data according to the invention, particularly transmission of text information relating to the contents of the program, in particular series programs, to be received via a mobile radio terminal of the terminal user allows an ergonomic, portable solution to problems with existing transmission of television programs. Mobile radio terminals can be carried considerably more easily than mobile televisions, and there is no delay in providing the information to the terminal user as in the case of a video recording.

Information relating to programs to be transmitted to the terminal user can advantageously be pre-selected and stored prior to transmission.

The transmission costs are preferably allocated to a mobile radio terminal user in the mobile radio network taking into account data that identifies the user. These costs, may, for example, be debited from a credit on a telephone card, or be included in the terminal user's telephone bill.

In an embodiment, the present invention provides a method of transmitting data which represents contents of a television program. The method includes radio transmitting the data which represents contents of a television program from a transmitter to a mobile radio terminal. The transmitting step may further include transmitting text data which represents contents of the television program. The transmitting step may include transmitting video data which represents contents of the television program.

The method may include storing pre-selected television program information in memory, and transmitting the stored pre-selected television program information. The transmitting step may further include transmitting the stored pre-selected television program information by one of automatically, according to a predetermined schedule, on request, and combinations thereof.

The method may include matching a form of the data to display options of the mobile radio terminal. The method may include automatically billing costs for the transmission via a telephone bill for the a user of the mobile radio terminal. The method may pertain to data which represents only a portion the television program, and transmitting the data which represents only a portion of the television program from the transmitter to the mobile radio terminal.

In an embodiment, the present invention provides an apparatus for transmitting data which at least partially represents contents of a television program to a mobile radio terminal. The apparatus has a television program memory device capable of storing the television program, a data memory device having the data which at least partially represents contents of the television program, and a transmitter device connected to the television program memory device and the data memory device. The transmitter device transmits the data via a mobile radio network to the mobile radio terminal.

In an embodiment, the present invention provides an apparatus for transmitting data which at least partially represents contents of a television program to a mobile radio terminal. The apparatus has a device having a television program, a device having data which at least partially represents contents of the television program, and a transmitter connected to the device having the television program and the device having data which at least partially represents contents of the television program. The transmitter transmits the data via a mobile radio network to the mobile radio terminal.

The device having a television program may have a device having a live television program and/or a memory which stores a recorded television program. The device having data which at least partially represents contents of the television program may have a device having on-line generated data and/or a memory which stores the data.

An advantage of the present invention is to allow a user to receive the transmitted television programs, in particular series programs, while traveling as easily, ergonomically and efficiently as possible, and without the time delays of traditionally recoded transmissions.

Additional features and advantages of the present invention are described in, and will be apparent from, the following Detailed Description of the Invention and the figures.

### BRIEF DESCRIPTION OF THE FIGURES

FIG. 1 is a schematic block diagram of transmission to a mobile radio terminal according to the invention.

### DETAILED DESCRIPTION OF THE INVENTION

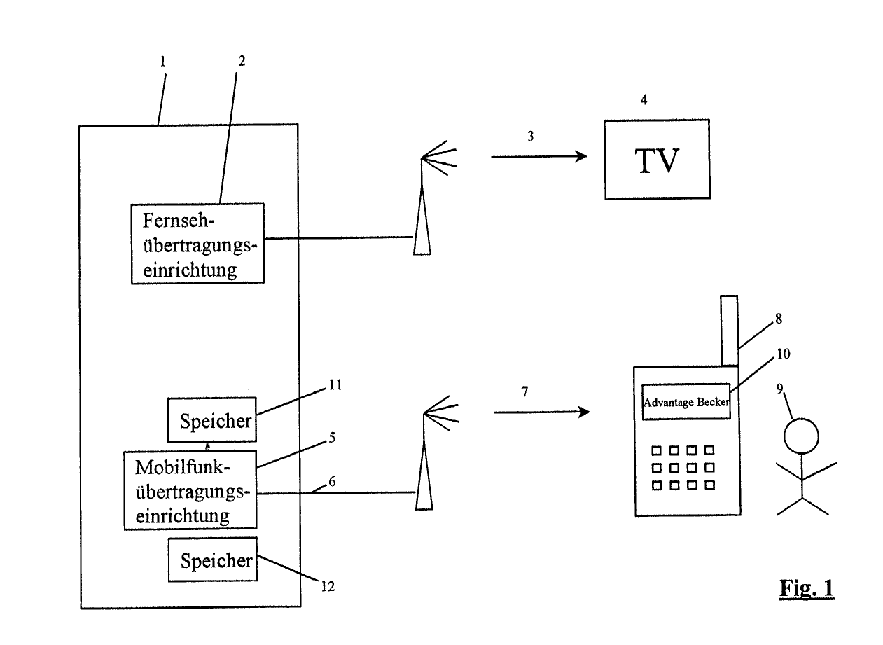

FIG. 1 shows, schematically, a television organization 1 which is using a television transmission device 2 in a conventional manner to transmit a television program by radio 3 to a television terminal 4 for displaying television pictures.

According to the invention, an apparatus 5 is provided in which trunk calls can provide mobile radio transmission of the data related to the television program. The transmitted data may include, for example, alphanumeric data from an editor on-line relating to the transmitted program (such as for sports programs) or alphanumeric information relating to the program entered in advance (such as for series programs). The transmitted data or information may be a reduced amount relative to the full transmitted television program. The transmitted data may be stored in a memory device 12 prior to transmission. The television program for which the data relates can be stored in a memory device 11. The information, particularly text alphanumeric information, is transmitted via a mobile radio network 6, 7 to a mobile radio terminal 8 of a user 9. The mobile radio terminal 8 has a visual display 10 and is capable of displaying the information it receives. The transmitted information may be, for example, displayed continuously on-line on a display 10 on the terminal 8 or stored in the terminal 8 and called up by the terminal user 9 by pushing a button, etc.

The invention can be used for widely different terminals, for example, GSM, UMTS or other multimedia terminals. The data transmitted to the mobile radio terminal may be, for example, a radio play with a commentary, text or comments by a sports reporter transmitted in spoken form or alphanumerically and relating to a live event (for example, football games, etc). At the mobile radio terminal end, the display or representation may be in the form of text, graphics, and speech, for example, and any combinations of those. Transmitted data relating to a television series may include, for example, a script for reading, videotext subtitles, or results of a sporting event (for example, of a football game). For series programs, transmissions may also be in the form of photographic comic scripts with still pictures and speech bubbles to indicate dialogues, or with an audio output in terminals 8 with an appropriate graphics/audio reproduction capability. Commentaries on sporting events or other commentary can be made in the form of text or audio. Video may also be displayed to communicate information, for example, video can be displayed to show goal opportunities in a football game on a terminal with appropriate video display capabilities.

According to the invention, program contents may be processed as appropriate before transmission to provide the data to be transmitted, for example in the case of a series program, or in parallel with the regular program transmission (on-line), for example in the case of live event programs. The method may also be used for educational programs, lectures, news programs, and any other programs.

It is possible for a television transmitter 1, 5 to store information, for example information pertaining to a series program, about what is to be transmitted to a specific terminal user 9 or terminal 8. For example, it is possible to provide for billing to be by subscription, such as an amount per month or per transmission. A reminder of the start of a program can be provided, for example, by means of a short message (SMS) or some other text message. In this case, for example, it is possible to ask the terminal user 9 whether the user 9 wants to see the program on the mobile radio terminal 8. If a positive input (such as “yes,” for example) is made on the terminal 8, the terminal 8 (using mobile radio, etc.) informs the device 5 at the transmitter end from where transmission is started. The user 9 can be identified, for example, by identification of the terminal 8. It is also possible to confirm which type of receiver 8 the user 9 has, for example, a terminal, a Windows-TE-based organizer, a GPS modem, a headset, or other device. The information is then transmitted to the user 9 in a form which is suitable for the user's receiving device 8. By way of example, the user 9 (the user's terminal 8 or other receiver device) can receive information relating to a television program in the form of photographs which are transmitted using a screening method and in relation to which the original audio of the television program is transmitted to the terminal 8. The costs for transmission can be billed in many different ways, for example, via a user's telephone bill or by debiting an amount from a prepaid card, or by debiting from an account in some other way.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A method of transmitting data which represents contents of a television program comprising radio transmitting the data which represents contents of a television program from a transmitter to a mobile radio terminal.

2. The method as claimed in claim 1, wherein the transmitting step further comprises transmitting text data which represents contents of the television program.

3. The method as claimed in claim 1, wherein the transmitting step further comprises transmitting video data which represents contents of the television program.

4. The method as claimed in claim 2, wherein the transmitting step further comprises transmitting video data which represents contents of the television program.

5. A method as claimed in claim 1, further comprising the step of storing pre-selected television program information in memory, and wherein the transmitting step further comprises transmitting the stored pre-selected television program information.

6. A method as claimed in claim 5, wherein the transmitting step further comprises transmitting the stored pre-selected television program information by one of automatically, according to a predetermined schedule, on request, and combinations thereof.

7. A method as claimed in claim 1, further comprising the step of matching a form of the data to display options of the mobile radio terminal.

8. A method as claimed in claim 1, further comprising the step of automatically billing costs for the transmission via a telephone bill for the a user of the mobile radio terminal.

9. A method as claimed in claim 1, wherein the data which represents contents of a television program represents only a portion the television program, and wherein the transmitting step further comprises transmitting the data which represents only a portion of the television program from the transmitter to the mobile radio terminal.

10. An apparatus for transmitting data which at least partially represents contents of a television program to a mobile radio terminal, comprising:
a television program memory device capable of storing the television program;
a data memory device having the data which at least partially represents contents of the television program; and
a transmitter device connected to the television program memory device and the data memory device, the transmitter device transmitting the data via a mobile radio network to the mobile radio terminal.

11. An apparatus for transmitting data which at least partially represents contents of a television program to a mobile radio terminal, comprising:
a device having a television program;
a device having data which at least partially represents contents of the television program; and
a transmitter connected to the device having the television program and the device having data which at least partially represents contents of the television program, the transmitter transmitting the data via a mobile radio network to the mobile radio terminal.

12. An apparatus according to claim 11, wherein the device having a television program further comprises one of a device having a live television program, a memory which stores a recorded television program, and combinations thereof.

13. An apparatus according to claim 11, wherein the device having data which at least partially represents contents of the television program further comprises one of a device having on-line generated data, a memory which stores the data, and combinations thereof.

14. An apparatus according to claim 12, wherein the device having data which at least partially represents contents of the television program further comprises one of a device having on-line generated data, a memory which stores the data, and combinations thereof.
